(19) United States
(12) Patent Application Publication
(10) Pub. No.: US 2023/0083296 A1
(43) Pub. Date: Mar. 16, 2023

(54) Baby Car Seat

(71) Applicants: Henry Martinez, Miami, FL (US); Joanna Streb, Miami, FL (US)

(72) Inventors: Henry Martinez, Miami, FL (US); Joanna Streb, Miami, FL (US)

(21) Appl. No.: 17/474,755

(22) Filed: Sep. 14, 2021

(51) Int. Cl. B60N 2/28; B60N 2/56; B60N 2/90

(52) U.S. Cl. CPC B60N 2/28; B60N 2/56; B60N 2/90; B60R 11/0217

(57) ABSTRACT

The main purpose of the disclosed invention is to provide users with a multi-functional baby car seat. This product has an internal speaker system that allows parents to soothe and entertain their child. The invention includes a thermal backrest and seat with heating and cooling controls that are designed to keep the child held by the seat at a comfortable temperature at all times. A retractable sun-reflecting shield is also part of this invention, and can protect the child from unwanted sun exposure. Every function of this car seat is controlled by a smartphone application. To guarantee the safety of the child held therein, this product sends essential alerts to the linked cellular device to help prevent critical situations such as when a child unbuckles the clip or if the infant is put at risk of vehicular heatstroke because of ambient temperature changes.

### BACKGROUND

A child safety seat, sometimes called an infant safety seat, child restraint system, child seat, baby seat, car seat, or a booster seat, is a seat designed specifically to protect children from injury or death during vehicle collisions. Most commonly these seats are purchased and installed by car owners, but car manufacturers may integrate them directly into their vehicles design and generally are required to provide anchors and ensure seat belt compatibility. Many jurisdictions require children defined by age, weight, and/or height to use a government-approved child safety seat when riding in a vehicle. Child safety seats provide passive restraints and must be properly used to be effective.

### SUMMARY OF THE INVENTION

The main purpose of the disclosed Baby Car Seat is to provide users with a multi-functional baby car seat with app controlled built-in speakers, thermal and cooling abilities, and an adjustable side-shield to block unwanted sun exposure. Car seats are one of the most crucial items of baby gear for all new parents. Modern designs of baby seats, however, can be uncomfortable and unsafe for infants, and impractical to install and use for parents. Ingenious and practical, the disclosed Baby Car Seat uses advanced smart technology to ensure child comfort and protection while seated in a car seat.

Expanding on the initial design of an average car seat, the disclosed Baby Car Seat introduces a novel mobile application that can be easily connected to the car seat to allow parents to control every function from the convenience of their smartphone/device. To guarantee the safety of the child held therein, this product sends essential alerts to the linked cellular device to help prevent critical situations such as when a child unbuckles the clip or if the infant is put at risk of vehicular heatstroke because of ambient temperature changes.

Moreover, the disclosed Baby Car Seat includes a thermal backrest and seat with heating and cooling controls that are designed to assure a parent that their child is at a comfortable temperature, at all times. To further enhance functionality, the retractable sun-reflecting shield can protect the child from unwanted sun exposure and prevents harmful UV rays from affecting a child.

The disclosed. Baby Car Seat also has an unprecedented built-in internal speaker system that allows parents to play lullaby to soothe and entertain their child. The disclosed Baby Car Seat ensures a fully operational infant car seat that provides paramount features to guarantee the safety and comfort of the child; thus, this unparalleled product may prove to be essential in the child care industry.

### BRIEF DESCRIPTION OF THE DRAWINGS

FIG. 1 is a frontal view of the BoujeeBaby Car Seat, showing the novel features in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

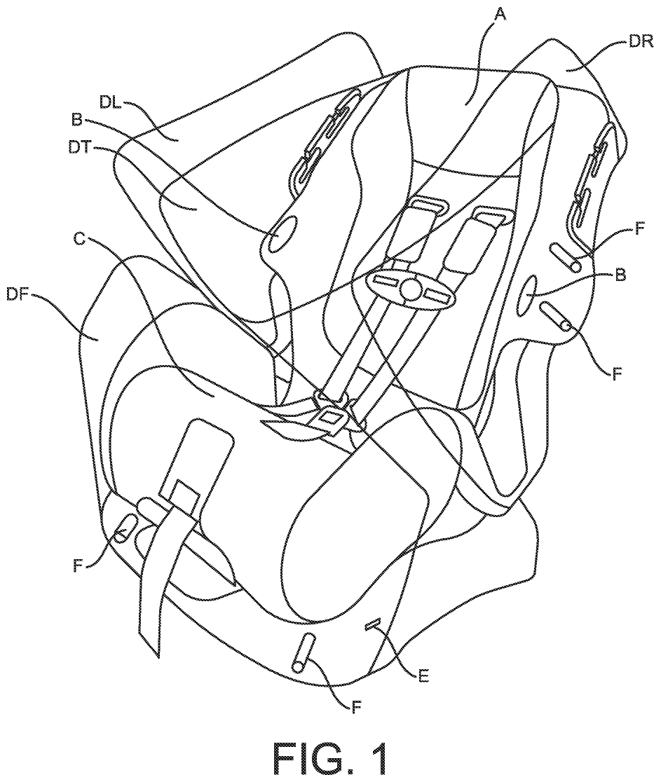

FIG. 1 is a frontal view of the BoujeeBaby Car Seat, showing the novel features in accordance with an embodiment of the present disclosure.

Reference A depicts the thermal back rest, which can change temperatures to keep the infant at a suitable temperature. The thermal back rest is controlled by the linked cellular device. Reference B depicts the built-in speakers, which are also controlled by the linked cellular device.

Reference C depicts the thermal seat, which functions the same as reference A, but as a seat instead of a back rest. Reference DL depicts the left side retractable sun-reflecting shield, DR the right side, DT the top side and DF the front side retractable sun-reflecting shields. Both references C and D are also controlled by the app on the linked cellular device.

Reference E depicts the charging port for the car seat. The charging port is used to power the car seat's features. Reference F are slide contacts which attach to the child vehicle seat and allow the respective shield to retract and to cover the child in the child vehicle seat according to a measure of control and monitoring via the disclosure.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A child vehicle seat comprising:
a temperature controlled seat and a temperature controlled back;
a speaker system integrated with the child vehicle seat; and
a shield attached to the child vehicle seat and configured to control an amount of light passing onto the child vehicle seat.

2. The child vehicle seat of claim 1, wherein the temperature controlled seat and controlled back allow an increase of temperature via an electrically resistive coil therein.

3. The child vehicle seat of claim 1, wherein the temperature controlled seat and controlled back allow a decrease in temperature via a cooled fluid circulation therein.

4. The child vehicle seat of claim 1, wherein the speaker system includes a pair of speakers proximal the temperature controlled back.

5. The child vehicle seat of claim 1, wherein the shield controls the amount of light passing onto the child vehicle seat via a raising and a lowering of the shield in reference to the temperature controlled back.

6. The child vehicle seat of claim 1, further comprising a remote controller for the temperature controlled seat and the temperature controlled back.

7. The child vehicle seat of claim 1, further comprising a remote controller for the shield configured to control an amount of light passing onto the child vehicle seat.

8. The child vehicle seat of claim 1, further comprising a remote controller for the speaker system configured to generate a white noise for a child occupant thereof.

9. The child vehicle seat of claim 1, further comprising a monitoring system configured to give remote feedback regarding an amount of light on the child vehicle seat.

10. The child vehicle seat of claim 1, further comprising a monitoring system in communication with an alert system for the temperature controlled seat and the temperature controlled back.

11. The child vehicle seat of claim 1, further comprising a cell phone application configured to generate an alert regarding a critical temperature sensed on the child vehicle seat.

12. The child vehicle seat of claim 1, further comprising a 12 volt connection to an electrical system of the vehicle to power the child vehicle seat.

13. The child vehicle seat of claim 1, wherein a control of the temperature controlled seat and a control of the temperature controlled back are separately controlled.

14. The child vehicle seat of claim 1, wherein a control of the temperature controlled seat and a control of the temperature controlled back are controlled together.

15. The child vehicle seat of claim 1, wherein the speaker system is in communication with a cell phone.

16. The child vehicle seat of claim 1, wherein the shield blocks a sunlight onto a side of the child vehicle seat.

17. The child vehicle seat of claim 1, wherein the shield blocks sunlight onto a front of the child vehicle seat.

18. The child vehicle seat of claim 1, wherein the shield blocks sunlight onto a back of the child vehicle seat.

19. The child vehicle seat of claim 1, wherein the shield blocks sunlight onto a top of the child vehicle seat.

20. The child vehicle seat of claim 1, wherein the shield blocks sunlight onto a front, a back, a top and both sides of the child vehicle seat.
